(19) United States
(12) Patent Application Publication
(10) Pub. No.: US 2024/0121166 A1
(43) Pub. Date: Apr. 11, 2024

(54) INFORMATION PROCESSING DEVICE, INFORMATION PROCESSING SYSTEM, INFORMATION PROCESSING METHOD, AND STORAGE MEDIUM STORING INFORMATION PROCESSING PROGRAM

(71) Applicant: Mitsubishi Electric Corporation, Tokyo (JP)

(72) Inventors: Wataru SASAKI, Tokyo (JP); Tatsuhiko ITOHARA, Tokyo (JP)

(73) Assignee: Mitsubishi Electric Corporation, Tokyo (JP)

(21) Appl. No.: 18/571,735

(22) PCT Filed: Jun. 24, 2021
(86) PCT No.: PCT/JP2021/023974

§ 371 Date: Dec. 19, 2023

(51) Int. Cl. H04L 41/16; G06N 5/04

(52) U.S. Cl. CPC H04L 41/16; G06N 5/04; G06F 3/0484

(57) ABSTRACT

An information processing device includes processing circuitry to manage a rule regarding cooperation of a plurality of devices, to acquire device operation information indicating a user operation on a first device and to infer the rule including a trigger condition as a condition for starting a cooperation device operation on a second device; to notify the terminal of an inquiry including the inferred rule via the communication unit and to acquire response information regarding whether to register the rule or not from the terminal; and to perform the cooperation device operation based on the rule when the device operation information satisfying the trigger condition included in the registered rule is inputted to the first device, wherein the processing circuitry registers the rule when the response information indicates approval for the registration of the rule, and performs the cooperation device operation based on the registered rule.

### TECHNICAL FIELD

The present disclosure relates to an information processing device, an information processing system, an information processing method, and an information processing program.

### BACKGROUND ART

Patent Reference 1 proposes a cooperation server as a device that manages rules each stipulating a process of causing an operation execution server, as a server for providing an operation execution service, to execute a predetermined action in response to a trigger that is provision of predetermined information from an information provision server for providing information provision services. According to a modification command for modifying a rule, this cooperation server modifies a rule not being the target of the modification command (i.e., another rule), being a rule that can be modified in the same way as the rule being the target of the modification command, together with the rule being the target of the modification command.

### PRIOR ART REFERENCE

### Patent Reference

Patent Reference 1: Japanese Patent Application Publication No. 2017-102643 (claim 1 and paragraph 0022, for example).

### SUMMARY OF THE INVENTION

### Problem to be Solved by the Invention

However, the above-described device does not execute a process of inferring a rule from information indicating a device operation performed by a user. With the above-described device, the user needs to manually generate the modification command for the rule as the target, and thus there is a problem in that modifications of rules cannot be made with ease.

An object of the present disclosure is to provide an information processing device, an information processing system, an information processing method, and an information processing program that make it possible to easily modify rules for implementing cooperation of operations of devices.

### Means for Solving the Problem

An information processing device in the present disclosure includes a communication unit to execute communication with an external device such as a terminal; a rule management unit to manage a rule regarding cooperation of a plurality of devices; a notification management unit; and a device management unit, wherein the rule management unit acquires device operation information indicating a user operation on a first device among the plurality of devices and infers the rule including a trigger condition as a condition for starting a cooperation device operation on a second device among the plurality of devices, based on the device operation information, the notification management unit notifies the terminal of an inquiry including the inferred rule via the communication unit and acquires a response regarding whether to register the rule or not from the terminal, the rule management unit registers the rule when the response indicates approval for the registration of the rule, and the device management unit performs the cooperation device operation based on the rule when the device operation information satisfying the trigger condition included in the registered rule is inputted to the first device.

An information processing method in the present disclosure is a method executed by an information processing device that executes communication with external devices such as a terminal and manages a rule regarding cooperation of a plurality of devices. The information processing method includes a step of acquiring device operation information indicating a user operation on a first device among the plurality of devices and inferring the rule including a trigger condition as a condition for starting a cooperation device operation on a second device among the plurality of devices, based on the device operation information, a step of notifying the terminal of an inquiry including the inferred rule and acquiring a response regarding whether to register the rule or not from the terminal, a step of registering the rule when the response indicates approval for the registration of the rule, and a step of performing the cooperation device operation based on the rule when the device operation information satisfying the trigger condition included in the registered rule is inputted to the first device.

### Effect of the Invention

According to the present disclosure, rules for implementing the cooperation of operations of devices can be modified with ease.

### BRIEF DESCRIPTION OF THE DRAWINGS

FIG. 1 is a diagram showing the general outline of an information processing system according to a first embodiment.

FIG. 2 is a diagram showing the general outline of rule inference and rule registration executed by the information processing system shown in FIG. 1.

FIG. 3 is a diagram showing the general outline of rule discarding executed by the information processing system shown in FIG. 1.

FIG. 4 is a block diagram showing an example of the configuration of an information processing device and a terminal shown in FIG. 1.

FIG. 5 is a diagram showing data structure and a concrete example of device management information stored in a device management information storage unit of a device management unit of the information processing device shown in FIG. 4.

FIGS. 6A and 6B are diagrams showing examples of displaying of inquiry information on the terminal.

FIG. 7 is a block diagram showing an example of the hardware configuration of the information processing device shown in FIG. 1 and FIG. 4.

FIG. 8 is a block diagram showing an example of the hardware configuration of the terminal shown in FIG. 1 and FIG. 4.

FIG. 9 is a flowchart showing an example of a process for rule registration executed by the information processing system according to the first embodiment.

FIG. 10 is a flowchart showing an example of a process for rule discarding executed by the information processing system according to the first embodiment.

FIG. 11 is a diagram showing the general outline of an information processing system according to a second embodiment.

FIG. 12 is a diagram showing the general outline of rule inference and rule registration executed by the information processing system shown in FIG. 11.

FIG. 13 is a block diagram showing an example of the configuration of the information processing device and the terminal shown in FIG. 11.

FIG. 14 is a diagram showing data structure and a concrete example of sensor management information stored in a sensor management information storage unit of a sensor management unit of the information processing device shown in FIG. 13.

FIG. 15 is a flowchart showing an example of a process for rule registration executed by the information processing system according to the second embodiment.

### MODE FOR CARRYING OUT THE INVENTION

An information processing device, an information processing system, an information processing method, and an information processing program according to each embodiment will be described below with reference to the drawings. The following embodiments are just examples and it is possible to appropriately combine embodiments and appropriately modify each embodiment.

### First Embodiment

### [General Outline of Information Processing System]

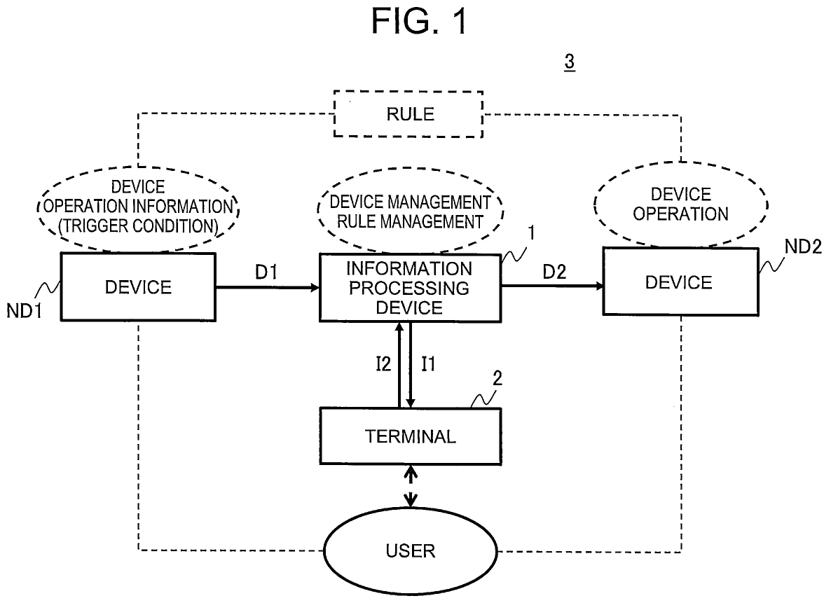

FIG. 1 is a diagram showing the general outline of an information processing system 3 according to a first embodiment. The information processing system 3 is a system that provides device operations. The information processing system 3 performs a device operation based on a rule regarding cooperation of a plurality of devices. The rule includes a series of operation steps, each indicating an operation on a device, and a trigger condition. That is, in the information processing system 3, when a user performs an operation satisfying the trigger condition on a device (e.g., ND1 as a target device), an information processing device 1 performs a device operation on a remaining device (e.g., ND2 as a cooperation device different from the target device) based on the rule. Specifically, the trigger condition is a condition regarding an operation on the target device, and when device operation information D1 indicating an operation on the target device satisfies the trigger condition, the cooperation device in cooperation with the target device automatically executes an operation stipulated by the rule based on cooperation device operation information D2. Accordingly, the information processing system 3 is capable of providing a device operation service as a combination of a variety of device operations.

The information processing system 3 includes the information processing device 1 that provides device management, rule management and notification management and a terminal 2 as an inquiry destination when an inquiry regarding the state of a rule is sent from the information processing device 1. The information processing device 1 is a computer, for example. The terminal 2 is a terminal device such as a smartphone, a tablet terminal or a personal computer (PC), for example.

The plurality of devices include a device ND1 that transmits the device operation information D1 to the information processing device 1 and a device ND2 that executes an operation based on the cooperation device operation information D2 received from the information processing device 1. While the device ND1 can be one device, the device ND1 can also be a plurality of devices ND1_1, ND1_2, . . . , ND1_m (m is a positive integer). Further, while the device ND2 can be one device, the device ND2 can also be a plurality of devices ND2_2, ND2_2, . . . , ND2_n (n is a positive integer). The device ND1 and the device ND2 are examples of household electric appliances, for example, and are referred to also as devices ND. Each device ND can also be an electric device other than a household electric appliance.

When the device ND1 is operated by the user, the device ND1 transmits the device operation information D1 to the information processing device 1. Then, the information processing device 1 performs the device operation on the device ND2 by transmitting the cooperation device operation information to the device ND2. That is, when the user performs an operation on the device ND1, the device operation on the device ND2 by the information processing device 1 is performed automatically, and the device ND2 executes an operation based on the received cooperation device operation information D2.

Each device ND has one or both of the function of transmitting the device operation information D1 to the information processing device 1 and the function of executing the operation based on the cooperation device operation information D2 received from the information processing device 1. In the example of FIG. 1, the device ND1 has the function of transmitting the device operation information D1 to the information processing device 1, and the device ND2 has the function of executing the operation based on the received cooperation device operation information D2.

The information processing device 1 manages rules regarding the cooperation of a plurality of devices ND. The information processing device 1 acquires the device operation information D1 indicating a user operation on the device ND1 (referred to also as a “first device”) among the plurality of devices ND, and based on the device operation information D1, infers a rule including the trigger condition as a condition for starting a cooperation device operation on the device ND2 (referred to also as a “second device”) among the plurality of devices ND. The information processing device 1 notifies the terminal 2 of an inquiry Il including the inferred rule, and acquires a response 12 regarding whether to register the rule or not from the terminal 2. When the response 12 indicates approval for the registration of the rule, the information processing device 1 registers the rule. When device operation information D1 satisfying a trigger condition included in a registered rule is inputted to the device ND1, the information processing device 1 performs the cooperation device operation based on the corresponding rule.

In FIG. 1, the user carries the terminal 2, and the information processing device 1 notifies the user of the rule (including the trigger condition in the rule) through the terminal 2.

### [Inference and Registration of Rule]

When the device operation information D1 is acquired from the device ND1, the information processing device 1 makes inference of a rule (including the trigger condition) based on the device operation information D1. Upon making the inference of the rule (including the trigger condition), the information processing device 1 notifies the user's terminal 2 of the inquiry Il regarding the rule (including the trigger condition). When the user's response 12 approving the registration of the rule (including the trigger condition) is transmitted from the terminal 2 in response to the inquiry Il regarding the rule (including the trigger condition), the information processing device 1 registers the rule (including the trigger condition).

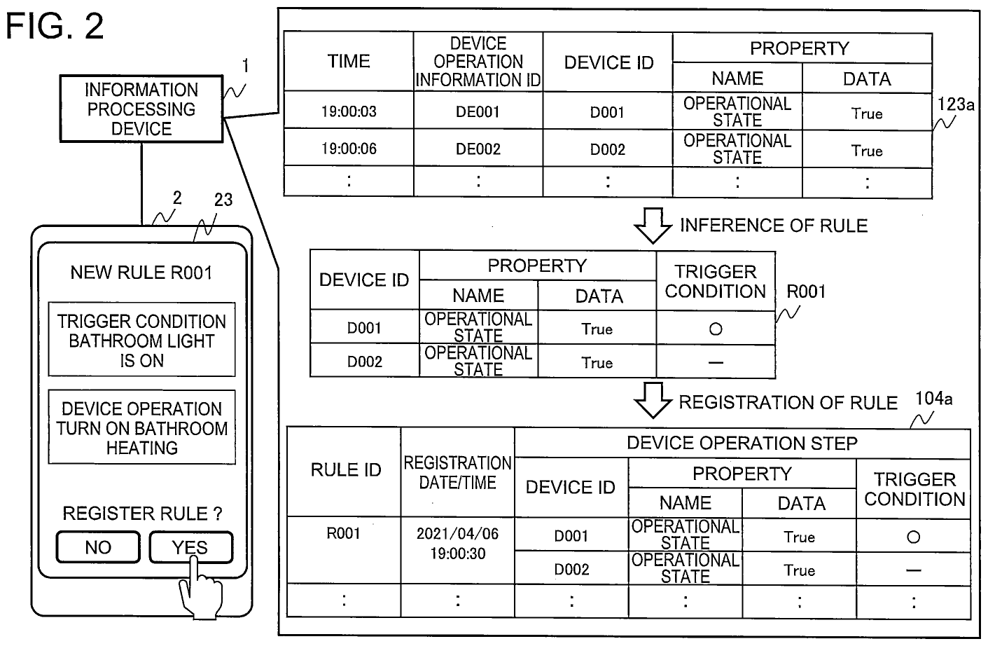

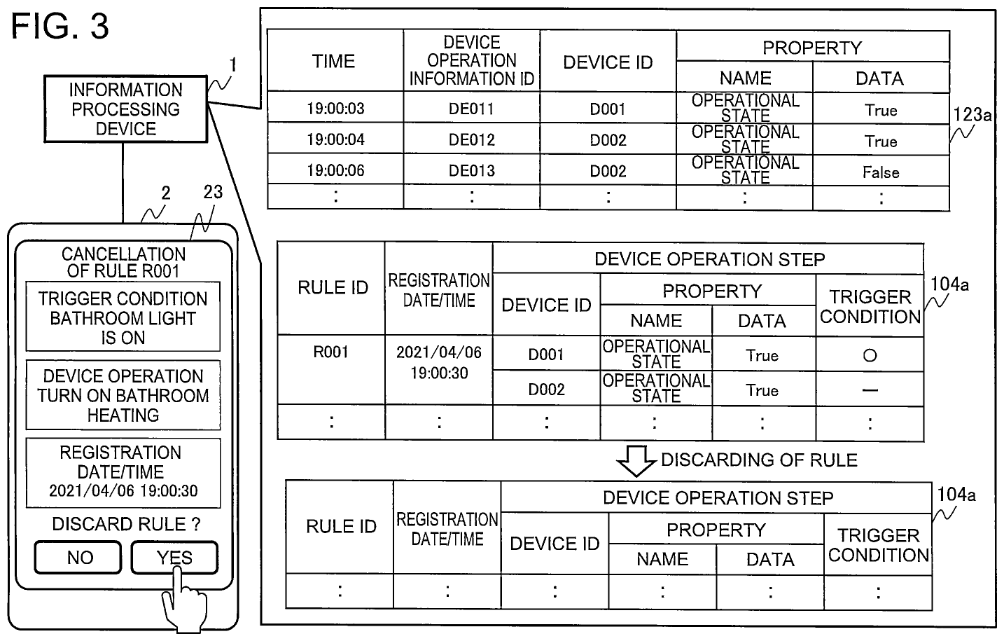

FIG. 2 is a diagram showing the general outline of the rule inference and the rule registration executed by the information processing system 3 shown in FIG. 1. First, management of registered rules will be described below. The information processing device 1 manages and stores rule management information 104a in a storage device (e.g., rule management information storage unit 104 in FIG. 3 which will be explained later). The rule management information 104a is information about rules generated by the information processing device 1, and is stored in a storage device in the information processing device 1 or an external storage device capable of communicating with the information processing device 1. The rule management information 104a is desired to be generated in regard to each user. That is, the rule management information 104a can be a plurality of pieces of information. The plurality of pieces of rule management information 104a are respectively associated with a plurality of user IDs for identifying a plurality of users.

The rule management information 104a shown in FIG. 2 is a database that manages a rule ID as identification information on a rule, information indicating a registration date/time of the rule, and a series of device operation steps while associating them with each other. In the example of FIG. 2, each device operation step includes a device ID for identifying the device, property information, and trigger condition information indicating whether the device operation step is the trigger condition (indicated by a circle “∘”) or not (indicated by “-”). In FIG. 2, D001 and D002 are shown as concrete examples of the device ND indicated by the device ID. In the following description, D001 represents a bathroom light and D002 represents bathroom heating. However, examples of the device ND are not limited to bathroom lights or bathroom heating but can include other electric devices.

The information processing device 1 is capable of performing the device operations according to the rules registered as the rule management information 104a by referring to the rule management information 104a. For example, in a rule whose rule ID is R001, the device operation step being the trigger condition has been described to mean that the operational state of the bathroom light as the device with the device ID D001 is True (i.e., power is on). Further, in this rule, the remaining device operation step has been described to mean that the operational state of the bathroom heating as the device with the device ID D002 is True (i.e., power is on). Therefore, when the information processing device 1 judges that the trigger condition is satisfied, the information processing device 1 is capable of setting the operational state of the bathroom heating (D002) as one device ND at True (i.e., power is on).

Further, as shown in FIG. 2, in the information processing device 1, device operation information regarding the devices ND is accumulated as device operation information 123a. The device operation information 123a shown in FIG. 2 includes a time (of day) indicating time information, a device operation information ID indicating identification information on the device operation information, a device ID indicating identification information on the device, and property information. Shown as concrete examples of the device operation information on a device ND represented by a device operation information ID in FIG. 2 are the device operation information with the device operation information ID DE001 occurring at 19:00:03 and indicating that the operational state of the bathroom light is True (i.e., power is on) and the device operation information with the device operation information ID DE002 occurring at 19:00:06 and indicating that the operational state of the bathroom heating is True (i.e., power is on). However, the device operation information 123a accumulated is not limited to the information shown in FIG. 2 but can also be different information.

The information processing device 1 infers a rule by referring to the device operation information 123a. In the example shown in FIG. 2, from the device operation information 123a indicating that the device operation represented by DE002 was performed after the device operation represented by DE001, the information processing device 1 infers the rule R001 in which triggers are the device operation represented by DE001 (i.e., operation of turning on the power of the bathroom light) and the device operation represented by DE002 (i.e., operation of turning on the power of the bathroom heating). However, the rule inference executed by the information processing device 1 is not limited to the example shown in FIG. 2.

Upon completing the rule inference, the information processing device 1 transmits a notification of the rule (including the trigger condition) to the terminal 2. This notification enables the user to recognize that the rule has been inferred and select whether or not to register the rule (including the trigger condition) indicated by the notification. In the example of FIG. 2, the terminal 2 displays information regarding the rule R001 in the form of text on a display unit 23 such as a touch panel. For example, the terminal 2 displays an inquiry (i.e., question sentence) “REGISTER RULE ?” on the display unit 23 in order to ask whether or not to register the rule R001. The user can transmit the response 12 indicating whether or not to register the rule (including the trigger condition) by operating either of a “YES” button and a “NO” button displayed on the display unit 23 of the terminal 2. However, the display content on the display unit 23 of the terminal 2 is not limited to the example of FIG. 2.

When registration approval for the rule is given in response to the notification on the terminal 2, the information processing device 1 registers the rule in the rule management information storage unit 104 as the rule management information 104a. In the example of FIG. 2, the user presses the “YES” button on the terminal 2 and accordingly the information processing device 1 registers the rule R001. As above, the user can make the information processing device 1 infer a rule for the cooperation device operation from the device operation information D1 occurring in daily life and register the rule when the approval from the user is obtained.

### [Discarding of Rule]

The above description is given by taking an example of the rule stipulating that the power of the bathroom heating should be turned on when the power of the bathroom light is turned on. However, in summer, for example, the user can think that turning on the power of the bathroom heating is unnecessary.

Therefore, in the information processing system 3, after the start of performing the remaining device operation based on the rule, when device operation information indicating the user's cancellation of the remaining device operation is acquired, an inquiry Il regarding whether to discard the registration of the rule or not is sent to the terminal 2, and the rule is discarded when a response 12 indicating the discarding of the rule is acquired from the user.

FIG. 3 is a diagram showing the general outline of the rule discarding executed by the information processing system 3 shown in FIG. 1. In FIG. 3, each component having the same function as a component described in FIG. 2 is assigned the same reference character as in FIG. 2. In the example shown in FIG. 3, DE011 represents device operation information occurring at 19:00:03 and indicating that the operational state of the bathroom light is True (i.e., power is on), DE012 represents device operation information occurring at 19:00:06 and indicating that the operational state of the bathroom heating is True (i.e., power is on), and DE013 represents device operation information occurring at 19:00:06 and indicating that the power of the bathroom heating is off,

When device operation information corresponding to an already-existing trigger condition is acquired by referring to the device operation information 123a, the information processing device 1 performs the remaining device operation in the rule. The example of FIG. 3 shows an example in which an operation for setting the operational state of D001 at True (i.e., power is on) is performed, the operational state of D002 is accordingly set at True (i.e., power is on), and thereafter the user performed a device operation of manually turning off the power of the bathroom heating.

When a device operation for canceling a rule (in the example of FIG. 3, turning off the power of the bathroom heating by the user after the power of the bathroom heating was turned on according to the rule R001) is performed, the information processing device 1 sends a notification regarding the discarding of the rule to the terminal 2. This notification allows the user to recognize that the rule is unnecessary and select whether or not to discard the rule. In the example of FIG. 3, the response to the inquiry “DISCARD RULE ?” regarding whether to discard the rule R001 or not is confirmed by using the button of “YES” or “NO”.

When the discarding approval for the rule is given by the response transmitted from the terminal 2, the information processing device 1 discards the rule in the rule management information 104a. In the example of FIG. 3, the user presses the “YES” button on the terminal 2 and accordingly the information processing device 1 discards the rule R001. As above, the information processing device 1 makes the judgment on the cancellation of a rule based on the device operation information occurring in the user's daily life, and discards the rule for which the discarding approval is acquired based on the user's intention.

### [Configuration of Information Processing Device and Terminal]

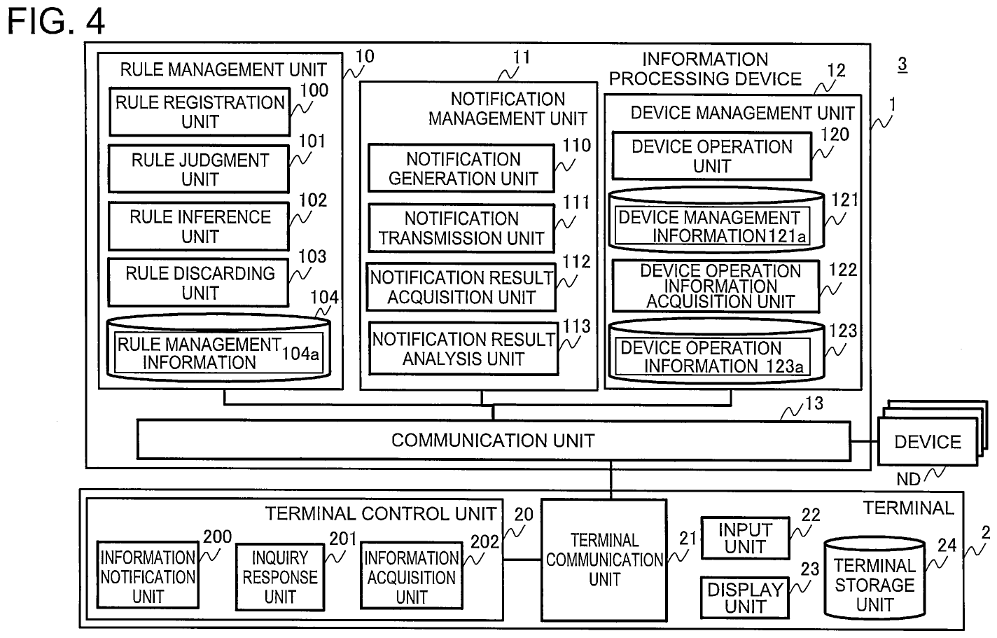

FIG. 4 is a block diagram showing an example of the configuration of the information processing device 1 and the terminal 2. Here, the information processing device 1 will be described first, and thereafter the terminal 2 will be described.

### [Configuration of Information Processing Device]

The information processing device 1 includes a rule management unit 10 that manages rules of device operations, a notification management unit 11 for sending notifications to the terminal 2, a device management unit 12 that acquires the device operation information and performs device operations, and a communication unit 13 for letting the information processing device 1 execute communication with external devices such as the terminal 2. FIG. 4 shows an example in which one communication unit 13 executes the communication with the terminal 2 and the devices ND. However, the information processing device 1 may execute the communication via different communication units (i.e., communication interfaces) depending on the device at the other end of the communication.

The rule management unit 10 manages rules. Specifically, the rule management unit 10 executes the registration, the judgment, the inference and the discarding of rules. The rule management unit 10 includes a rule registration unit 100, a rule judgment unit 101, a rule inference unit 102, a rule discarding unit 103 and a rule management information storage unit 104.

The rule registration unit 100 registers a rule based on rule information acquired from the notification management unit 11. Specifically, the rule registration unit 100 acquires the rule information based on the device operation information from the notification management unit 11 and stores the rule information in the rule management information storage unit 104.

Each time the device management unit 12 receives device operation information from a device ND, the rule judgment unit 101 judges whether or not the device operation information is device operation information corresponding to a trigger condition stored in the rule management information storage unit 104, and when the device operation information corresponds to a trigger condition, the device management unit 12 commands the device management unit 12 to perform the remaining device operation step(s) in the rule. Further, after the start of performing the remaining device operation step(s) in the rule, each time the device management unit 12 acquires device operation information from the device ND, the rule judgment unit 101 judges whether or not the device operation information is device operation information indicating the user's cancellation of the remaining device operation, and if the device operation information is device operation information indicating the cancellation, the rule judgment unit 101 commands the notification management unit 11 to send the inquiry regarding whether or not to discard the registration of the rule.

The device operation information regarding the cancellation of a device operation indicates, for example, the user's operation of turning off the power of a device ND after a device operation unit 120 turned on the power of the device ND by a device operation step in a predetermined rule. In another example, the device operation information regarding the cancellation of a device operation indicates, the user's operation of setting the mode of a device ND to “mode Y” after the user set the mode of the device ND to “mode X”.

The rule inference unit 102 infers a rule (including the trigger condition), indicating a series of operation steps each indicating the user's operation on a device, from one or more pieces of device operation information stored in the device management unit 12. For example, a case where the user takes actions of turning on the bathroom light and thereafter turning on the bathroom heating will be explained below. Based on the series of actions, the rule inference unit 102 makes an operation step inference such as predicting a device operation of turning on the bathroom heating as the next device operation when there is device operation information indicating the turning on of the bathroom light.

In such an operation step inference, when a series of device operation steps has appeared a predetermined number of times (i.e., threshold value) or more, the rule inference unit 102 may infer that the series of device operation steps is a rule. Further, the rule inference unit 102 may calculate a device operation step based on time-series data of normalized device operation information by using an LSTM (Long Short Term Memory) network as a type of a recurrent neural network. The rule inference unit 102 may infer the above-described pattern based on not only a device operation learning model implemented by the LSTM network but also a non-deep learning machine learning model formed as an ensemble of K-nearest neighbor algorithm, decision tree, random forest and SVM (Support Vector Machine), or the like, for example. Furthermore, data used for the inference can include date/time information. When the date/time information is used for the inference of a device operation step, information such as the same time every day and particular day of the week every week contributes to the inference of the device operation step.

Further, when the rule inference unit 102 uses machine learning, the rule inference unit 102 operates as a machine learning device to which the device operation information occurring due to device operations by the user, is inputted, generates a learned model, and stores the learned model in a storage device (e.g., the rule management information storage unit 104). When device operation information D1 satisfying a trigger condition is inputted to the target device, the device management unit 12 may execute a process of performing the cooperation device operation on a cooperation device based on the rule by using the learned model.

The rule discarding unit 103 discards the rule information stored in the rule management information storage unit 104 based on rule discarding approval information acquired from the notification management unit 11. For example, when the notification management unit 11 receives a notification result from the terminal 2 and the result of analyzing the notification result is information indicating the discarding approval for a rule, the rule discarding unit 103 identifies the rule based on the acquired discarding approval information and discards the rule from the rule management information 104a.

In the rule management information storage unit 104, rules are stored as the rule management information 104a.

The notification management unit 11 manages notifications. Specifically, the notification management unit 11 executes generation, transmission, result acquisition and result analysis of notifications. The notification management unit 11 includes a notification generation unit 110, a notification transmission unit 111, a notification result acquisition unit 112 and a notification result analysis unit 113.

The notification generation unit 110 generates a notification (i.e., inquiry) based on the rule inferred by the rule management unit 10. The notification is, for example, an inquiry regarding whether or not the user approves the registration of the inferred rule (including the trigger condition).

The notification transmission unit 111 transmits the notification generated by the notification generation unit 110 to the terminal 2.

The notification result acquisition unit 112 acquires the notification result (i.e., response to the inquiry). Specifically, when the response to the notification is made by the terminal 2, the notification result acquisition unit 112 acquires the response as the notification result. For example, for the notification inquiring whether or not to register the inferred rule, the question sentence regarding the registration of the rule and the buttons of “YES” and “NO” are displayed on the terminal 2, and the notification result acquisition unit 112 receives the result of the selection as registration approval or registration disapproval depending on the operation on the “YES” or “NO” button.

The notification is not limited to a notification for the purpose of screen display but can also be a notification of a different type such as speech.

The notification result analysis unit 113 analyzes the notification received by the notification result acquisition unit 112 and transmits the rule to the rule management unit 10 as needed. For example, the notification result analysis unit 113 analyzes whether or not to register the rule by analyzing a registration approval notification result, and transmits the rule to the rule management unit 10 when the analysis result is information indicating the registration.

The device management unit 12 manages devices. Specifically, the device management unit 12 executes the acquisition of the device operation information and the device operations in regard to the devices ND as targets. The device management unit 12 includes the device operation unit 120, a device management information storage unit 121, a device operation information acquisition unit 122 and a device operation information storage unit 123.

The device operation information acquisition unit 122 acquires the device operation information from a device ND. The device operation unit 120 performs the device operation on a device ND.

The device management information storage unit 121 stores device management information 121a. Here, the device management information 121a is information regarding each device ND, and is generated for each device ND.

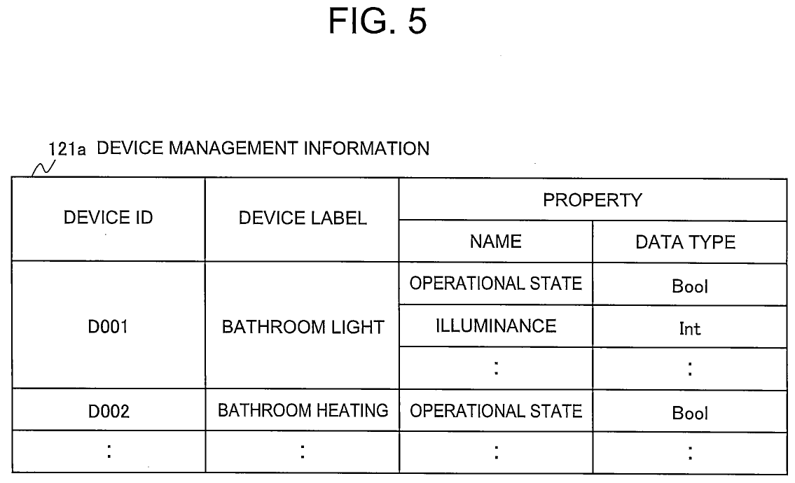

FIG. 5 is a diagram showing data structure and a concrete example of the device management information 121a stored in the device management information storage unit 121 of the device management unit 12 of the information processing device 1 shown in FIG. 4. The device management information storage unit 121 in FIG. 5 has stored device IDs as identification information on the devices ND, device label information (“DEVICE LABEL” in FIG. 5) as the name of each device ND presented on the terminal 2 to the user, and property information (“PROPERTY” in FIG. 5) as definitions of variables describing the state of each device.

In the property information, a name of a property and a data type of the property are linked (associated) with each other. One or more pieces of property information exist for one device ID.

In the example of FIG. 5, for the device ND with the device ID D001, the device label information is “BATHROOM LIGHT”, and on the terminal 2, the user is presented with the device ND by the name of “BATHROOM LIGHT”. Further, each device ND can have data of the Boolean datatype as its operational state, and the operational state is settable and acquirable. In the Boolean datatype in regard to the operational state, True is handled as “power is on” and False is handled as “power is off”.

The device operation information storage unit 123 stores the device operation information 123a acquired by the device operation information acquisition unit 122. The device operation information 123a may include a date, a time, and so forth.

The device operation unit 120 performs the device operations. For example, when the target of the operation is an air conditioner as a household electric appliance, the device operation unit 120 performs, for example, turning on/off the power of the device (appliance), switching between modes such as heating and cooling, or changing the temperature setting.

### [Configuration of Terminal]

The terminal 2 includes a terminal control unit 20 having centralized control over units of the terminal 2, a terminal communication unit 21 for letting the terminal 2 communicate with other devices, an input unit 22 that receives the user's input operations, the display unit 23 that displays a screen according to control by the terminal control unit 20, and a terminal storage unit 24 that stores various types of data used by the terminal 2.

The terminal control unit 20 includes an information notification unit 200, an inquiry response unit 201 and an information acquisition unit 202. These units may also be implemented by installing application software in the terminal 2, for example.

The information notification unit 200 transmits various types of information acquired from the inquiry response unit 201 to the information processing device via the terminal communication unit 21.

The inquiry response unit 201 has a predetermined user interface (UI) screen displayed and thereby makes a notification regarding the rule. Specifically, the inquiry response unit 201 has an inquiry screen regarding the registration or the discarding of the rule displayed as one of UI screens, and receives various designations regarding the state of the rule inferred by the rule inference unit 102 of the information processing device 1.

The information acquisition unit 202 acquires various types of information acquired from the notification transmission unit 111 of the notification management unit 11 of the information processing device 1 and outputs the acquired information to the inquiry response unit 201.

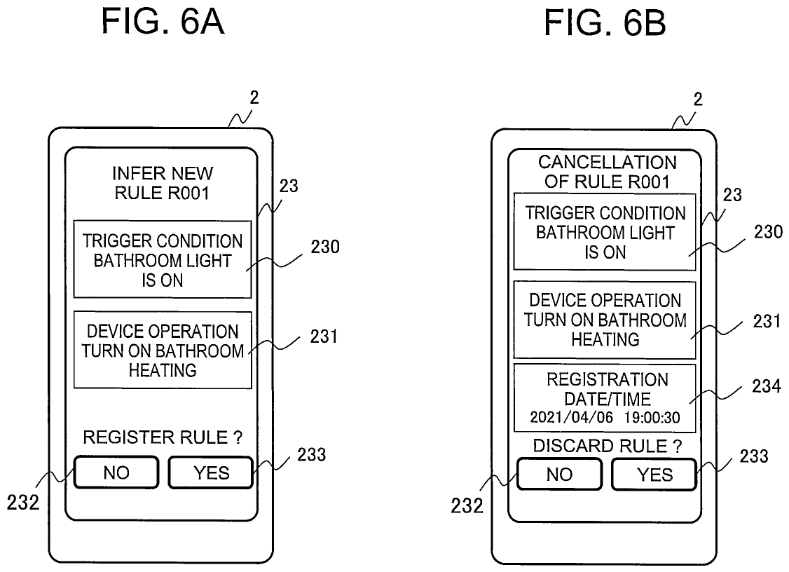

FIGS. 6A and 6B are diagrams showing examples of the displaying of inquiry information on the terminal 2. The inquiry screen is a screen for making an inquiry regarding the registration or the discarding of the rule, such as the screens shown in FIGS. 6A and 6B, for example. The inquiry screen shown in each of FIGS. 6A and 6B is a screen for inquiring whether or not to approve a state of the rule R001, and includes a trigger condition display part 230, a device operation display part 231, a “NO” button 232, a “YES” button 233 and a registration date/time display part 234. The inquiry response unit 201 outputs the inquiry information acquired by the information acquisition unit 202.

The inquiry response unit 201 has the rule information displayed in the trigger condition display part 230, the device operation display part 231 and the registration date/time display part 234 of the inquiry screen according to inquiry screen data. FIG. 6A shows an example of the inquiry regarding the rule registration when a new rule has been inferred, displaying “BATHROOM LIGHT IS ON” as the trigger condition in the rule R001 and “TURN ON BATHROOM HEATING” as the device operation. Here, if the “NO” button 232 is selected by the user, the inquiry response unit 201 outputs rule registration disapproval information to the information notification unit 200. Then, the information notification unit 200 transmits the acquired rule registration disapproval information to the information processing device 1. In contrast, if the “YES” button 233 is selected by the user, the inquiry response unit 201 outputs rule registration approval information to the information notification unit 200. Then, the information notification unit 200 transmits the acquired rule registration approval information to the information processing device 1, and the information processing device 1 registers the rule.

FIG. 6B shows an example of the inquiry regarding the rule discarding when the rule has been canceled, displaying “BATHROOM LIGHT IS ON” as the trigger condition in the rule R001 and “TURN ON BATHROOM HEATING” as the device operation. Here, if the “NO” button 232 is selected by the user, the inquiry response unit 201 outputs rule discarding disapproval information to the information notification unit 200. Then, the information notification unit 200 transmits the acquired rule discarding disapproval information to the information processing device 1. In contrast, if the “YES” button 233 is selected by the user, the inquiry response unit 201 outputs rule discarding approval information to the information notification unit 200. Then, the information notification unit 200 transmits the acquired rule discarding approval information to the information processing device 1, and the information processing device 1 discards the rule.

### [Hardware Configuration]

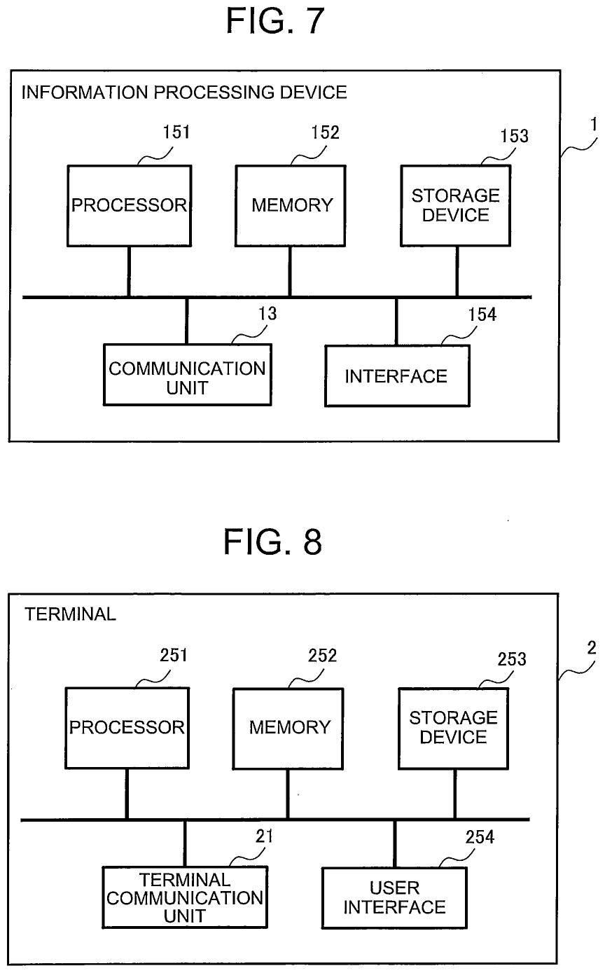

FIG. 7 is a block diagram showing an example of the hardware configuration of the information processing device 1 shown in FIG. 1 and FIG. 4. The information processing device 1 includes a processor 151 such as a CPU (Central Processing Unit), a memory 152, and a storage device 153. The memory 152 is, for example, a volatile semiconductor memory such as a RAM (Random Access Memory). The storage device 153 is, for example, a nonvolatile storage device such as a hard disk drive (HDD) or a solid state drive (SSD). Further, the information processing device 1 includes the communication unit 13 and an interface 154.

Functions of the information processing device 1 are implemented by processing circuitry. The processing circuitry can be either dedicated hardware or the processor 151 executing a program stored in the memory 152. The processor 151 can be any one of a processing device, an arithmetic device, a microprocessor, a microcomputer and a DSP (Digital Signal Processor).

In the case where the processing circuitry is the processor 151, the information processing program is implemented by software, firmware or a combination of software and firmware. The software and the firmware are described as programs and stored in the memory 152. The processor 151 implements the functions of the units shown in FIG. 4 by reading out and executing the information processing program stored in the memory 152.

Incidentally, it is also possible to implement part of the information processing device 1 by dedicated hardware and implement part of the information processing device 1 by software or firmware. As above, the processing circuitry is capable of implementing the above-described functions by hardware, software, firmware or a combination of some of these means.

FIG. 8 is a block diagram showing an example of the hardware configuration of the terminal 2 shown in FIG. 1 and FIG. 4. The terminal 2 includes a processor 251 such as a CPU, a memory 252, and a storage device 253. The memory 252 is a RAM, for example. The storage device 253 is an SSD, for example. Further, the terminal 2 includes the terminal communication unit 21 and a user interface 254 such as a touch panel.

Functions of the terminal 2 are implemented by processing circuitry. The processing circuitry can be either dedicated hardware or the processor 251 executing a program stored in the memory 252. The processor 251 can be any one of a processing device, an arithmetic device, a microprocessor, a microcomputer and a DSP.

### [Process Regarding Registration of Rule]

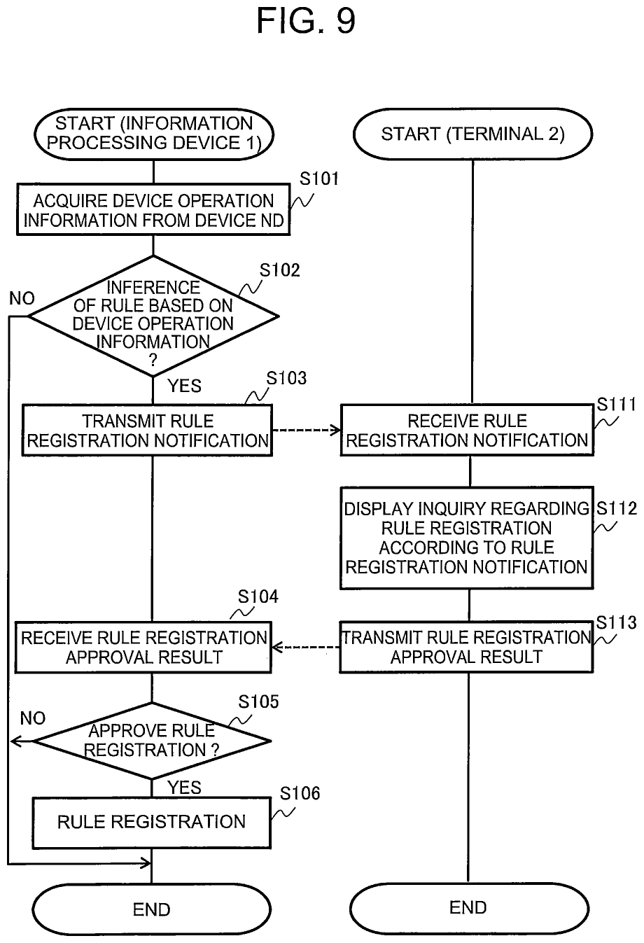

FIG. 9 is a flowchart showing an example of a process for the rule registration executed by the information processing system 3 according to the first embodiment. To execute the process regarding the rule registration, first, the device operation information acquisition unit 122 of the device management unit 12 acquires the device operation information from a device ND (step S101). The acquired device operation information is stored in the device operation information storage unit 123 of the device management unit 12 as the device operation information 123a.

Subsequently, the rule inference unit 102 of the rule management unit 10 makes the inference of a rule (including the trigger condition) based on the device operation information (step S102). When the inference of the rule (including the trigger condition) is made successfully (YES in the step S102), the rule inference unit 102 transmits the inferred rule information to the notification management unit 11. In contrast, when the inference of the rule (including the trigger condition) fails (NO in the step S103), the rule inference unit 102 ends the rule inference process.

When the inferred rule information is acquired, the notification generation unit 110 of the notification management unit 11 generates a rule registration notification (i.e., inquiry regarding whether or not to approve the registration) and makes the notification transmission unit 111 transmit the rule registration notification to the terminal 2 via the communication unit 13 (step S103).

The information acquisition unit 202 of the terminal 2 receives the rule registration notification via the terminal communication unit 21 (step S111). Subsequently, the inquiry response unit 201 of the terminal 2 makes the display unit 23 display the inquiry screen (e.g., FIG. 6A) according to the rule registration notification (step S112). This allows the user to answer whether to approve the registration of the rule or not by operating the terminal 2. The inquiry response unit 201 generates a rule registration approval result corresponding to the user operation and outputs the rule registration approval result to the information notification unit 200. The information notification unit 200 notifies the information processing device 1 of the acquired rule registration approval result via the terminal communication unit 21 (step S113). Then, the notification management unit 11 of the information processing device 1 acquires the rule registration approval result via the communication unit 13 (step S104).

Subsequently, the notification result acquisition unit 112 of the notification management unit 11 of the information processing device 1 outputs the rule registration approval result to the notification result analysis unit 113. The notification result analysis unit 113 analyzes the rule registration approval result. When the result of the analysis of the rule registration approval result is information indicating the registration (YES in step S105), the notification result analysis unit 113 outputs the rule information to the rule registration unit 100. When the result of the analysis is not information indicating the registration (NO in the step S105), the process for the rule registration executed by the information processing device 1 and the terminal 2 ends.

When acquiring the rule information, the rule registration unit 100 registers the rule in the rule management information storage unit 104 as the rule management information 104a (step S106). At this point, the process for the rule registration executed by the information processing device 1 and the terminal 2 ends.

### [Process Regarding Discarding of Rule]

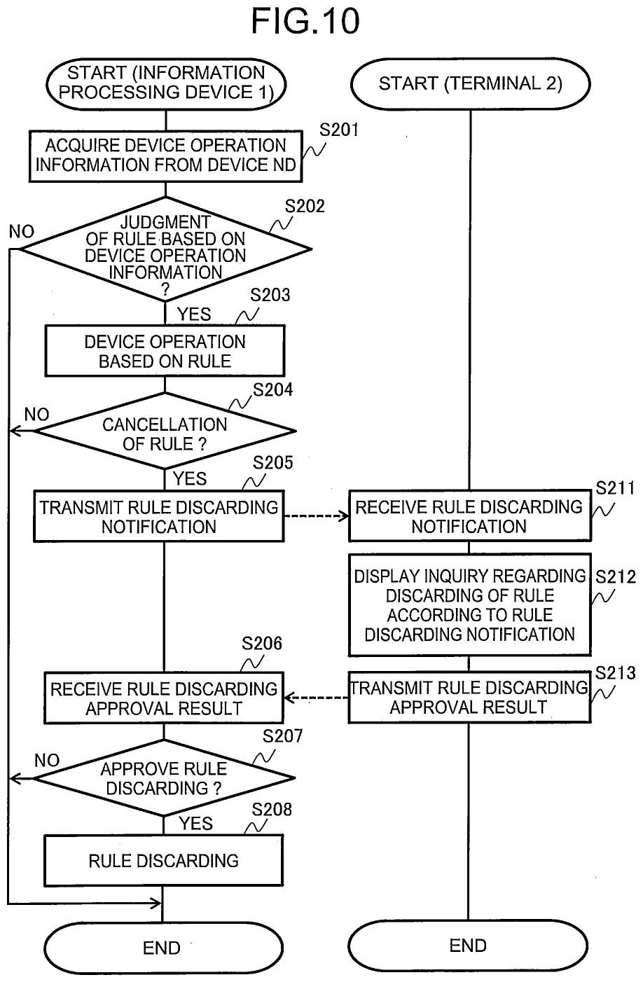

FIG. 10 is a flowchart showing an example of a process for the rule discarding executed by the information processing system 3.

To execute the process regarding the rule discarding, first, the device operation information acquisition unit 122 of the information processing device 1 acquires the device operation information from the device ND (step S201). The acquired device operation information is stored in the device operation information storage unit 123. Subsequently, the rule judgment unit 101 judges whether the device operation information matches a trigger condition or not based on the rule management information 104a registered in the rule management information storage unit 104 (step S202). When the device operation information matches a trigger condition (YES in the step S202), the rule judgment unit 101 commands the device operation unit 120 of the device management unit 12 to execute the remaining device operation step(s) in the rule so as to perform the device operation (step S203). In contrast, when the device operation information does not match a trigger condition (NO in the step S202), the information processing device 1 ends the process for the rule discarding.

When device operation information indicating cancellation of the remaining device operation is acquired after the start of performing the remaining device operation step(s) (YES in step S204), the rule judgment unit 101 commands the notification generation unit 110 of the notification management unit 11 to make the inquiry regarding whether or not to discard the registration of the rule. In contrast, when no device operation information indicating the cancellation is acquired (NO in the step S204), the information processing device 1 ends the process.

When the rule information regarding the cancellation is acquired, the notification generation unit 110 of the notification management unit 11 generates a rule discarding notification and makes the notification transmission unit 111 transmit the notification to the terminal 2 via the communication unit 13 (step S205).

The information acquisition unit 202 of the terminal 2 receives the rule discarding notification via the terminal communication unit 21 (step S211). Subsequently, the inquiry response unit 201 of the terminal 2 makes the display unit 23 display the inquiry screen (e.g., FIG. 6B) according to the rule discarding notification (step S212). This enables the user to answer whether to discard the rule or not by operating the terminal 2. The inquiry response unit 201 generates a rule discarding approval result corresponding to the user operation and outputs the rule discarding approval result to the information notification unit 200. The information notification unit 200 notifies the information processing device 1 of the acquired rule discarding approval result via the terminal communication unit 21 (step S213). Then, the notification management unit 11 of the information processing device 1 acquires the rule discarding approval result via the communication unit 13 (step S206).

Subsequently, the notification result acquisition unit 112 of the notification management unit 11 of the information processing device 1 outputs the rule discarding approval result to the notification result analysis unit 113. The notification result analysis unit 113 analyzes the rule discarding approval result. When the result of the analysis of the rule discarding approval result is information indicating the discarding (YES in step S207), the notification result analysis unit 113 outputs the rule information to the rule discarding unit 103. When the result of the analysis is not information indicating the discarding (NO in the step S207), the process executed by the information processing device 1 and the terminal 2 ends.

When the rule information is acquired, the rule discarding unit 103 discards the rule information from the rule management information 104a (step S208). At this point, the process for the rule discarding executed by the information processing device 1 and the terminal 2 ends.

As described above, with the information processing device 1 according to the first embodiment, a rule (including the trigger condition in the rule) is inferred from the device operation information occurring in the user's daily life, the notification of the rule (including the trigger condition in the rule) is sent to the user, and the registration approval information indicating whether to register the rule or not is acquired from the user, by which the rule registration according to the user's intention is made possible.

Further, with the information processing device 1 according to the first embodiment, when device operation information indicating the user's cancellation of the remaining device operation is acquired after the start of performing the device operation based on the rule, the inquiry regarding whether to discard the rule or not is sent to the user, and the rule is discarded when the discarding approval information is acquired from the user, by which the update of rules changing day by day can be made with ease.

### Second Embodiment

The information processing device 1 according to the first embodiment executes the inference, the registration and the discarding of each rule stipulating the cooperation device operation based on the device operation information generated due to the device operations performed by the user. In contrast, an information processing device 1a according to a second embodiment executes the inference, the registration and the discarding of each rule stipulating the cooperation device operation based on the device operation information occurring due to the device operations performed by the user and sensor information acquired from a sensor.

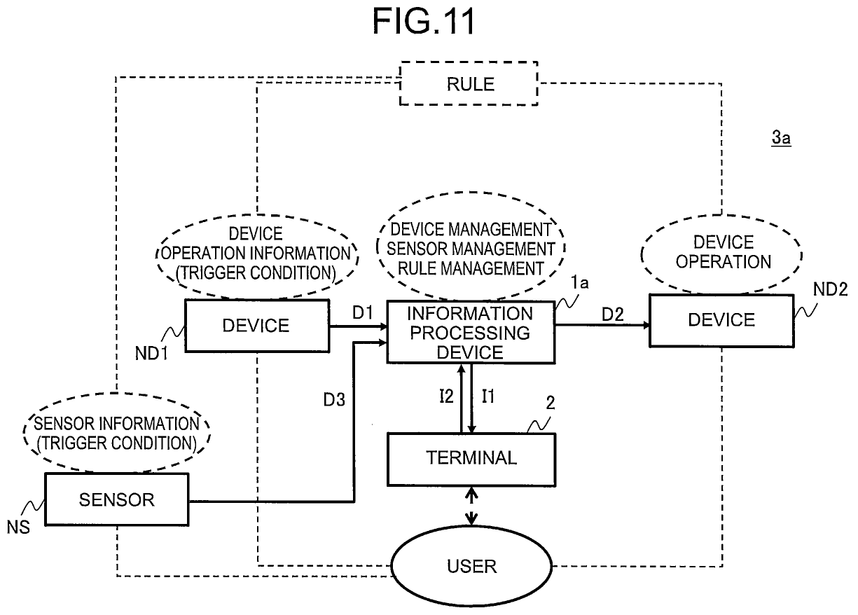

FIG. 11 is a diagram showing the general outline of an information processing system 3a according to the second embodiment. In FIG. 11, each component having the same function as a component described in FIG. 1 is assigned the same reference character as in FIG. 1.

In the information processing system 3a, the information processing device 1a performs the device operation based on the rule. The rule is formed of a series of operation steps each indicating the user's operation on a device and the trigger condition. That is, in the information processing system 3a, when predetermined sensor information satisfying a predetermined trigger condition is acquired, the remaining device operation is performed based on the rule. Accordingly, it is possible to provide a device operation service by use of a combination of a variety of sensor information and device operation information.

The information processing system 3a in FIG. 11 includes the information processing device 1 that provides the device management, sensor management and the rule management, the devices ND each of which executes the transmission of the device operation information or the device operation, a sensor NS that executes the transmission of the sensor information, and the terminal 2 to which the inquiry regarding a state of a rule is sent from the information processing device 1.

The sensor NS transmits the sensor information to the information processing device 1a when the user is detected, for example. Then, the information processing device 1a performs the device operation on a device ND. Accordingly, the device operation on the device ND can be performed upon acquisition of the information from the sensor NS. Further, the sensor NS can be one or more sensors.

The device ND is desired to have the function of transmitting the device operation information. In the second embodiment, an example in which the sensor NS is a human detection sensor will be described.

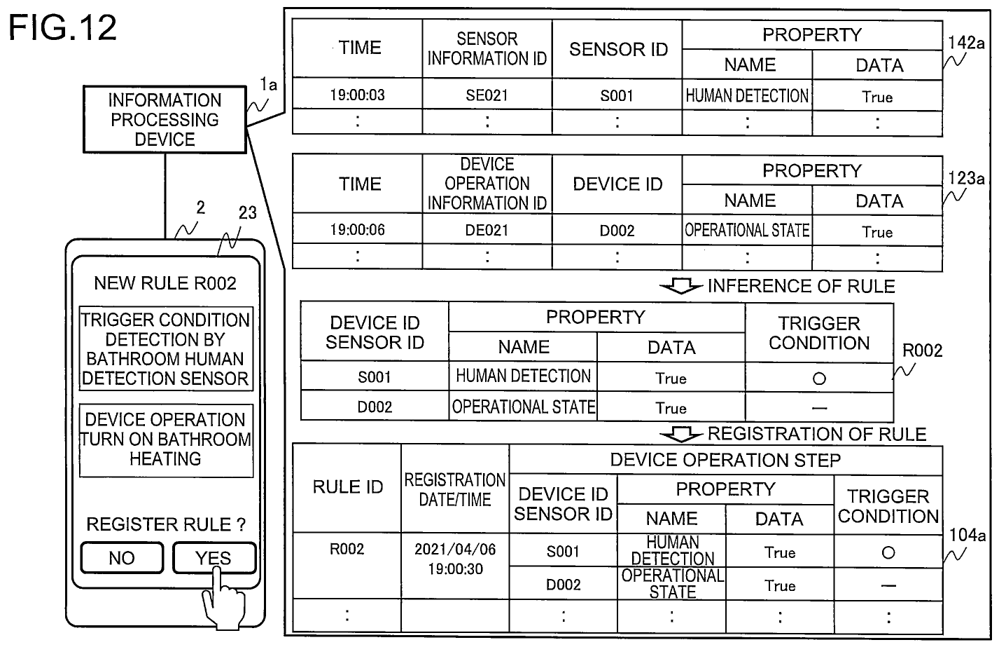

FIG. 12 is a diagram showing the general outline of the rule inference and the rule registration executed by the information processing system 3a shown in FIG. 11.

First, a description will be given of an example in which the sensor, specifically, the human detection sensor, is installed in a bathroom. As shown in FIG. 12, the sensor information from the human detection sensor is accumulated in sensor information 142a. The sensor information 142a in FIG. 12 includes a time (of day) indicating time information, a sensor information ID indicating identification information on the sensor information, a sensor ID indicating identification information on the sensor, and property information. As a concrete example of the sensor information from the sensor indicated by the sensor information 142a in FIG. 12, the sensor information with the sensor information ID SE021 occurring at 19:00:03 and indicating that a human detection state of the human detection sensor in the bathroom is True (i.e., human is detected) will be described below: however, this embodiment is not limited to this example. Further, as a concrete example of the device operation information 123a in FIG. 12, the device operation information with the device operation information ID DE021 occurring at 19:00:06 and indicating that the operational state of the bathroom heating is True (i.e., power is on) will be described.

In the example of FIG. 12, since there is the device operation information indicating that DE021 is performed after the sensor information with the sensor information of SE021, the rule R002 in which the trigger condition is the sensor information with the sensor information of SE021, namely, the human detection reaction of the bathroom human detection sensor and the device operation is the device operation information with the device operation information of DE021, namely, turning on the bathroom heating is inferred from the sensor information 142a and the device operation information 123a.

When the rule inference unit 102 uses machine learning, the rule inference unit 102 operates as a machine learning device to which the device operation information occurring due to device operations by the user and the sensor information are inputted, generates a learned model, and stores the learned model in the storage device (e.g., the rule management information storage unit 104). When device operation information D1 satisfying a trigger condition is inputted to the target device, the device management unit 12 may execute the process of performing the cooperation device operation on the cooperation device based on the rule by using the learned model.

The rule registration after the rule inference is the same as that shown in FIG. 2. As above, the user can make the information processing device 1a infer a rule for the device operation from the sensor information and the device operation information occurring in daily life and register the rule based on the user's intention.

### [Configuration of Information Processing Device]

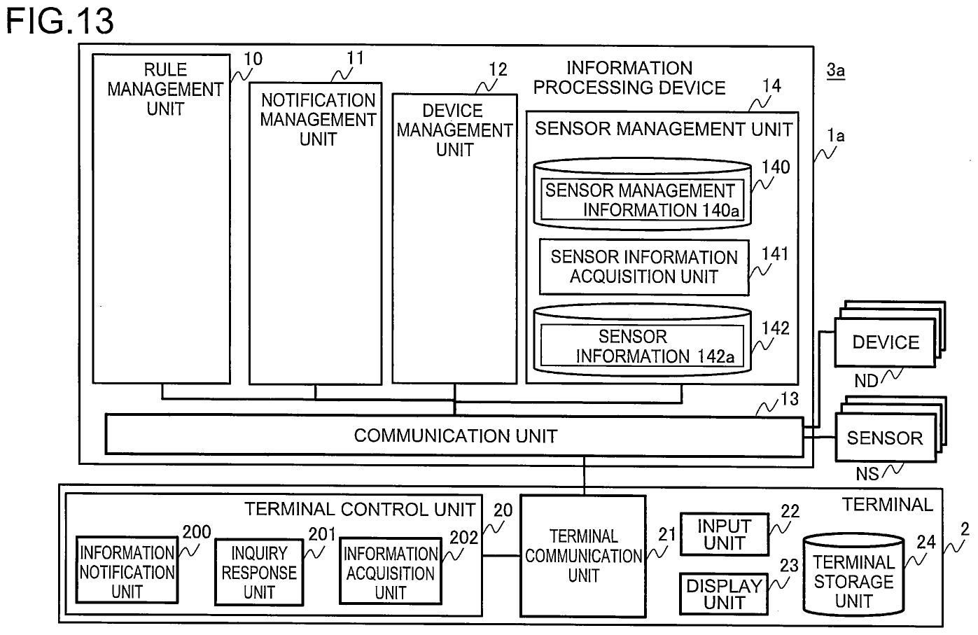

FIG. 13 is a block diagram showing an example of the configuration of the information processing device 1a and the terminal 2 included in the information processing system 3a shown in FIG. 11. In FIG. 13, each component having the same function as a component described in FIG. 4 is assigned the same reference character as in FIG. 4. As shown in FIG. 13, the information processing device 1a includes a sensor management unit 14. The communication unit 13 of the information processing device 1a is capable of communicating with the sensors NS.

While FIG. 13 shows an example in which one communication unit 13 executes the communication with the terminal 2, the devices ND and the sensors NS, the communication may be executed via different communication units (communication interfaces) depending on the device at the other end of the communication.

The sensor management unit 14 manages the sensors. Specifically, the sensor management unit 14 executes the acquisition of the sensor information from the sensors NS as the target. The sensor management unit 14 includes a sensor management information storage unit 140, a sensor information acquisition unit 141 and a sensor information storage unit 142. The sensor information acquisition unit 141 acquires the sensor information from the sensors NS.

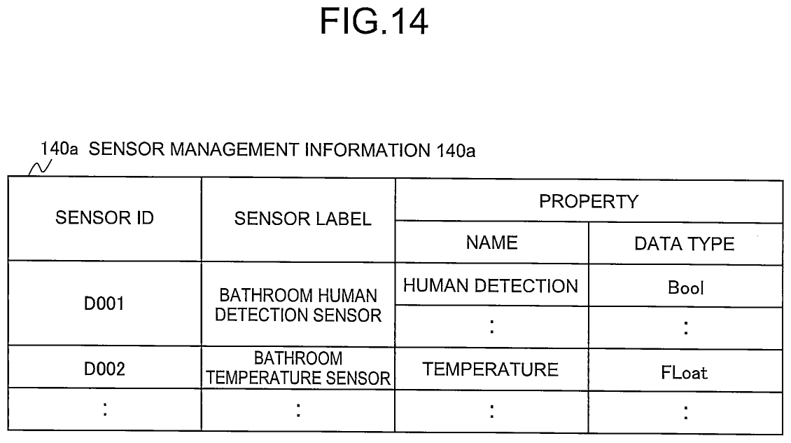

FIG. 14 is a diagram showing data structure and a concrete example of sensor management information 140a stored in the sensor management information storage unit 140. The sensor management information 140a is information regarding each sensor NS, and is generated in regard to each sensor NS.

The sensor management information 141a in FIG. 14 stores sensor IDs as identification information on the sensors NS, sensor label information (“SENSOR LABEL” in FIG. 14) as the name of each sensor NS presented on the terminal 2 to the user, and property information (“PROPERTY” in FIG. 14) as definitions of variables describing the state of each sensor.

In the property information, the name of a property and the data type of the property are linked (associated) with each other. One or more pieces of property information exist for one sensor ID.

In the example of FIG. 14, for the sensor NS with the sensor ID S001, the sensor label information is “BATHROOM HUMAN DETECTION SENSOR”, and on the terminal 2, the user is presented with the sensor NS by the name of “BATHROOM HUMAN DETECTION SENSOR”. Further, the sensor NS can have data of the Boolean datatype as its human detection state, and the human detection state is acquirable. In the Boolean datatype in regard to the human detection state, True is handled as “human detected” and False is handled as “human not detected”.

The sensor information storage unit 142 stores the sensor information acquired by the sensor information acquisition unit 141. The sensor information may include a date, a time, and so forth.

### [Process Regarding Registration of Rule]

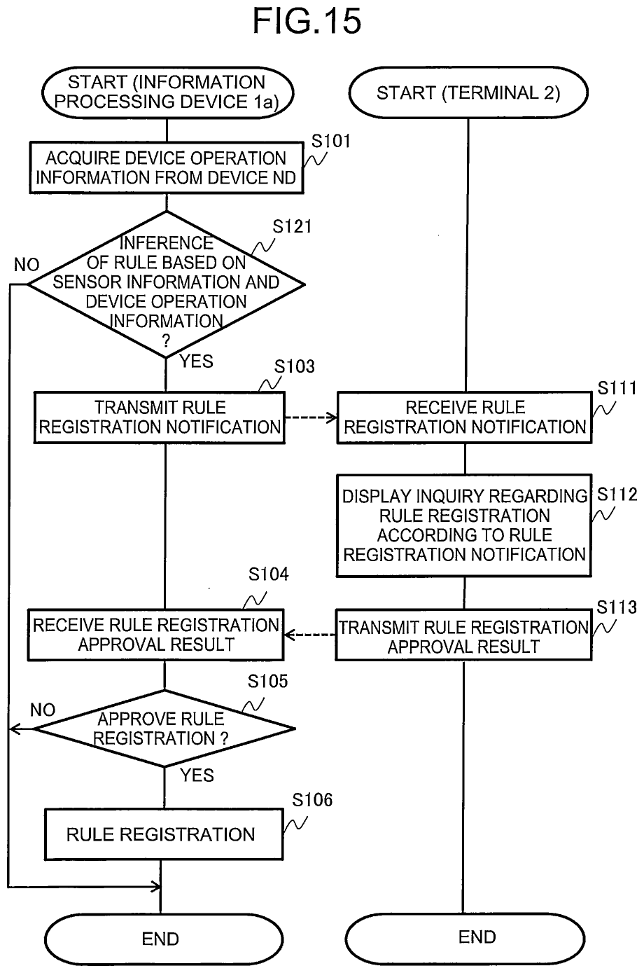

FIG. 15 is a flowchart showing an example of a process for the rule registration executed by the information processing system 3a according to the second embodiment. In FIG. 15, each component having the same function as the component described in FIG. 9 is assigned the same reference character as in FIG. 9.

In step S121, a rule is inferred based on the sensor information and the device operation information. Specifically, the rule inference unit 102 infers the rule (including the trigger condition) based on the information stored in the sensor information storage unit 142 and the device operation information storage unit 123. When the inference is successful (YES in the step S121), the rule (including the trigger condition) is transmitted to the notification management unit 11 and the process advances to the step S103. When the inference fails (NO in the step S121), the information processing device 1a ends the process. The processing from the step S103 is the same as that in FIG. 9.

As described above, with the information processing device 1a according to the second embodiment, a rule (including the trigger condition in the rule) is inferred from the device operation information and the sensor information occurring in the user's daily life, the notification of the rule is sent to the user, and the registration approval information indicating whether to register the rule or not is acquired from the user, by which the rule registration according to the user's intention is made possible.

Further, with the information processing device 1a according to the second embodiment, when device operation information indicating the user's cancellation of the remaining device operation is acquired, the inquiry regarding whether to discard the rule or not is sent to the user, and the rule is discarded when the discarding approval information is acquired from the user, by which the update of rules changing day by day can be made with ease.

Furthermore, with the configuration of the information processing device and the process regarding the rule registration according to the second embodiment, by using one or more items of information out of information from a temperature/humidity sensor and information from a human detection sensor as the input, it is possible to operate a device by using a season satisfying a certain temperature/humidity condition as one of the trigger conditions.

Moreover, the operation of the heating device while the bathroom is used for taking a bath and the operation of the heating device while the bathroom is used for drying cloths can be made different from each other.

### DESCRIPTION OF REFERENCE CHARACTERS

1, 1a: information processing device, 2: terminal, 3, 3a: information processing system, ND: device, ND1: device, ND2: device, NS: sensor, 10: rule management unit, 11: notification management unit, 12: device management unit, 13: communication unit, 14: sensor management unit, 20: terminal control unit, 21: terminal communication unit, 22: input unit, 23: display unit, 24: terminal storage unit, 100: rule registration unit, 101: rule judgment unit, 102: rule inference unit, 103: rule discarding unit, 104: rule management information storage unit, 104a: rule management information, 110: notification generation unit, 111: notification transmission unit, 112: notification result acquisition unit, 113: notification result analysis unit, 120: device operation unit, 121: device management information storage unit, 121a: device management information, 122: device operation information acquisition unit, 123: device operation information storage unit, 123a: device operation information, 140: sensor management information storage unit, 140a: sensor management information, 141: sensor information acquisition unit, 142: sensor information storage unit, 142a: sensor information, 200: information notification unit, 201: inquiry response unit, 202: information acquisition unit, 230: trigger condition display part, 231: device operation display part, 232: “NO” button, 233: “YES” button, 234: registration date/time display part.

1. An information processing device comprising:
processing circuitry
to execute communication with an external device such as a terminal;
to manage a rule regarding cooperation of a plurality of devices, to acquire device operation information indicating a user operation on a first device among the plurality of devices and to infer the rule including a trigger condition as a condition for starting a cooperation device operation on a second device among the plurality of devices, based on the device operation information;
to notify the terminal of an inquiry including the inferred rule via the communication unit and to acquire response information regarding whether to register the rule or not from the terminal; and
to perform the cooperation device operation based on the rule when the device operation information satisfying the trigger condition included in the registered rule is inputted to the first device, wherein
the processing circuitry registers the rule when the response information indicates approval for the registration of the rule, and
performs the cooperation device operation based on the registered rule.

2. The information processing device according to claim 9, wherein the processing circuitry
acquires sensor information as information detected by a sensor, and
infers the rule based on the device operation information and the sensor information.

3. The information processing device according to claim 9, wherein the processing circuitry
generates a learned model by inferring the rule by means of machine learning by use of the device operation information occurring due to operations on the plurality of devices by a user as input, and
performs the cooperation device operation based on the rule by using the learned model.

4. The information processing device according to claim 2, wherein the processing circuitry
generates a learned model by inferring the rule by means of machine learning by use of the device operation information occurring due to operations on the plurality of devices by a user and the sensor information as input, and
performs the cooperation device operation based on the rule by using the learned model.

5.-6. (canceled)

7. An information processing method executed by an information processing device that executes communication with external devices such as a terminal and manages a rule regarding cooperation of a plurality of devices, the method comprising:
acquiring device operation information indicating a user operation on a first device among the plurality of devices and inferring the rule including a trigger condition as a condition for starting a cooperation device operation on a second device among the plurality of devices, based on the device operation information;
notifying the terminal of an inquiry including the inferred rule and acquiring response information regarding whether to register the rule or not from the terminal;
registering the rule when the response information indicates approval for the registration of the rule;
performing the cooperation device operation based on the rule when the device operation information satisfying the trigger condition included in the registered rule is inputted to the first device;
notifying the terminal of an inquiry regarding whether or not to discard the registration of the rule stipulating the cooperation device operation and acquiring response information regarding whether to discard the rule or not from the terminal, when acquiring device operation information indicating cancellation of the cooperation device operation remaining after the cooperation device operation begins to be performed, and
discarding the rule for which the approval for the discarding is acquired, when the response information indicates approval for the discarding of the rule.

8. A non-transitory computer-readable storage medium storing an information processing program that causes a computer, which executes communication with external devices such as a terminal and manages a rule regarding cooperation of a plurality of devices, to execute:
acquiring device operation information indicating a user operation on a first device among the plurality of devices and inferring the rule including a trigger condition as a condition for starting a cooperation device operation on a second device among the plurality of devices, based on the device operation information;
notifying the terminal of an inquiry including the inferred rule and acquiring response information regarding whether to register the rule or not from the terminal;
registering the rule when the response information indicates approval for the registration of the rule;
performing the cooperation device operation based on the rule when the device operation information satisfying the trigger condition included in the registered rule is inputted to the first device;
notifying the terminal of an inquiry regarding whether or not to discard the registration of the rule stipulating the cooperation device operation and acquiring response information regarding whether to discard the rule or not from the terminal, when acquiring device operation information indicating cancellation of the cooperation device operation remaining after the cooperation device operation begins to be performed, and
discarding the rule for which the approval for the discarding is acquired, when the response information indicates approval for the discarding of the rule.

9. An information processing device comprising:
processing circuitry
to execute communication with an external device such as a terminal;
to manage a rule regarding cooperation of a plurality of devices, to acquire device operation information indicating a user operation on a first device among the plurality of devices and to infer the rule including a trigger condition as a condition for starting a cooperation device operation on a second device among the plurality of devices, based on the device operation information;
to notify the terminal of an inquiry including the inferred rule via the communication unit and to acquire response information regarding whether to register the rule or not from the terminal; and
to perform the cooperation device operation based on the rule when the device operation information satisfying the trigger condition included in the registered rule is inputted to the first device,
wherein the processing circuitry
registers the rule when the response information indicates approval for the registration of the rule,
performs the cooperation device operation based on the registered rule,
notifies the terminal of an inquiry regarding whether or not to discard the registration of the rule stipulating the cooperation device operation, and acquires response information regarding whether to discard the rule or not from the terminal, when acquiring device operation information indicating cancellation of the performed cooperation device operation, and
discards the rule for which the approval for the discarding is acquired, when the response information indicates approval for the discarding of the rule.

10. An information processing device comprising:
processing circuitry
to execute communication with an external device such as a terminal;
to manage a rule regarding cooperation of a plurality of devices based on device operation information indicating a user operation on a first device among the plurality of devices, the rule including a trigger condition as a condition for starting a cooperation device operation on a second device among the plurality of devices;
to notify the terminal of an inquiry including the rule via the communication unit and to acquire response information from the terminal; and
to perform the cooperation device operation based on the registered rule when the device operation information satisfying the trigger condition is inputted to the first device,
wherein the processing circuitry
registers the rule when the response information indicates approval for the registration of the rule,
performs the cooperation device operation based on the registered rule,
notifies the terminal of an inquiry regarding whether or not to discard the registered rule and acquires response information regarding whether to discard the rule or not from the terminal, when acquiring device operation information indicating a user operation different from the performed cooperation device operation, and
discards the rule for which the approval for the discarding is acquired, when the response information indicates approval for the discarding of the rule.

11. An information processing system comprising:
a terminal; and
processing circuitry
to execute communication with an external device such as a terminal;
to manage a rule regarding cooperation of a plurality of devices, to acquire device operation information indicating a user operation on a first device among the plurality of devices and to infer the rule including a trigger condition as a condition for starting a cooperation device operation on a second device among the plurality of devices, based on the device operation information;
to notify the terminal of an inquiry including the inferred rule via the communication unit and to acquire response information regarding whether to register the rule or not from the terminal; and
to perform the cooperation device operation based on the rule when the device operation information satisfying the trigger condition included in the registered rule is inputted to the first device,
wherein the processing circuitry
registers the rule when the response information indicates approval for the registration of the rule,
performs the cooperation device operation based on the registered rule,
notifies the terminal of an inquiry regarding whether or not to discard the registration of the rule stipulating the cooperation device operation, and acquires response information regarding whether to discard the rule or not from the terminal, when acquiring device operation information indicating cancellation of the performed cooperation device operation, and
discards the rule for which the approval for the discarding is acquired, when the response information indicates approval for the discarding of the rule.

12. An information processing system comprising:
a terminal; and
processing circuitry
to execute communication with an external device such as a terminal;
to manage a rule regarding cooperation of a plurality of devices based on device operation information indicating a user operation on a first device among the plurality of devices, the rule including a trigger condition as a condition for starting a cooperation device operation on a second device among the plurality of devices;
to notify the terminal of an inquiry including the rule via the communication unit and to acquire response information from the terminal; and
to perform the cooperation device operation based on the registered rule when the device operation information satisfying the trigger condition is inputted to the first device,
wherein the processing circuitry
registers the rule when the response information indicates approval for the registration of the rule,
performs the cooperation device operation based on the registered rule,
notifies the terminal of an inquiry regarding whether or not to discard the registered rule and acquires response information regarding whether to discard the rule or not from the terminal, when acquiring device operation information indicating a user operation different from the performed cooperation device operation, and
discards the rule for which the approval for the discarding is acquired, when the response information indicates approval for the discarding of the rule.
